(19) United States
(12) Patent Application Publication
(10) Pub. No.: US 2008/0244176 A1
(43) Pub. Date: Oct. 2, 2008

(54) INFORMATION PROCESSING DEVICE AND DISK ARRAY CONSTRUCTION METHOD

(75) Inventors: Kazuyuki Tanaka, Tachikawa-shi (JP); Takehiko Kurashige, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/048,004

(22) Filed: Mar. 13, 2008

(30) Foreign Application Priority Data
Mar. 29, 2007 (JP) 2007-088835

(51) Int. Cl. G06F 12/00

(52) U.S. Cl. 711/114; 711/E12.001

(57) ABSTRACT

According to one embodiment, an information processing device, includes a connecting port configured to be connected by a second storage device, having a plurality of areas to duplicate data to be stored by a internal storage device having a first capacity and to be disposed in a body, and of which the capacity of each area is larger than the first capacity, an inquiring unit configured to inquire to a user which of areas in the second storage device is selected for constructing a disk array, after the second storage device is connected to the connecting port, a rebuilding unit configured to rebuild the data in the internal storage device into the area selected by the user in response to the inquiry from the inquiring unit, and a disk array construction unit configured to construct the disk array by an area corresponding to the area selected by the user.

### CROSS-REFERENCE TO RELATED APPLICATIONS

This application is based upon and claims the benefit of priority from Japanese Patent Application No. 2007-088835, filed Mar. 29, 2007, the entire contents of which are incorporated herein by reference.

### BACKGROUND

1. Field

One embodiment of the present invention relates to an information processing device which constructs a disk array together with a detachable external storage device, and also relates to a disk array construction method.

2. Description of the Related Art

A disk array comprising a redundant array of independent disks (RAID) to be configured by using a plurality of disk drives, for example, a plurality of hard disk drives has been known as a storage device that offers high speed and high reliability.

Recently, a portable information processing device that can realize such disk array, for example, a notebook-size personal computer (hereinafter referred to as note PC) has appeared (Jpn. Pat. Appln. KOKAI Publication No. 2006-185374). This kind of note PC has a mounting unit, called a selectable bay, on which a hard disk drive (HDD), a CD-ROM drive, a DVD drive, etc., are mounted other than a pre-built-in HDD. The disk array is constructed by mounting the HDD on the mounting unit and constituted by the HDD and the HDD built in the note PC.

In the foregoing note PC, the disk array is constructed by the HDD mounted on the selectable bay and the built-in HDD. Mounting the HDD on the selectable bay, however, is troublesome, thus it is desired to construct the disk array by a HDD to be connected to an external device connecting port and the built-in HDD. As for the built-in HDD, because of a restriction on the size, a 1.8-inch HDD or a 2.5-inch HDD is employed. In the case of the HDD connected to the external connecting port, since there is no restriction on the size, the HDD also may employ a 3.5-inch HDD. Since the unit cost of the 3.5-inch HDD is lower than that of the 1.8-inch HDD or the 2.5-inch HDD, a HDD of a larger capacity than that of the built— in HDD may be selected.

However, if the HDD with a larger capacity is connected to the connecting port, but is only used to an extent similar to that of the built-in HDD, then the large capacity of the external HDD results in wastage.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an appearance seen from the front of an information processing device and an external HDD regarding one embodiment of the present invention;

FIG. 2 is an exemplary block diagram showing a system configuration of the information processing device and the external HDD of FIG. 1;

FIG. 3 is an exemplary view showing a state of construction of a RAID comprising the external HDD and an internal HDD;

FIG. 4 is another view showing the state to construction of the RAID comprising the external HDD and the internal HDD;

FIG. 5 is an exemplary block diagram showing a configuration of a RAID control function of the information processing device of FIG. 1;

FIG. 6 is an exemplary view showing a window to be displayed by a selection window generation unit of FIG. 5; and

FIG. 7 is an exemplary flowchart showing processing of the RAID control function shown in FIG. 5.

### DETAILED DESCRIPTION

Various embodiments according to the invention will be described hereinafter with reference to the accompanying drawings. In general, according to one embodiment of the invention, an information processing device, includes a body, an internal storage device configured to have a first capacity and to be disposed in the main body, a connecting port configured to be connected by a second storage device, having a plurality of areas to duplicate data to be stored by the internal storage device, and of which the capacity of each area is larger than the first capacity, a connection recognizing unit configured to recognize the fact that the second storage device is connected to the connecting port, an inquiring unit configured to inquire to a user which of areas in the second storage device is selected for constructing a disk array, when the connection is recognized, a rebuilding unit configured to rebuild the data in the internal storage device into the area selected by the user in response to the inquiry from the inquiring unit, and a disk array construction unit configured to construct the disk array by an area corresponding to the area selected by the user.

Hereinafter, embodiments of the invention will be described with reference to the drawings.

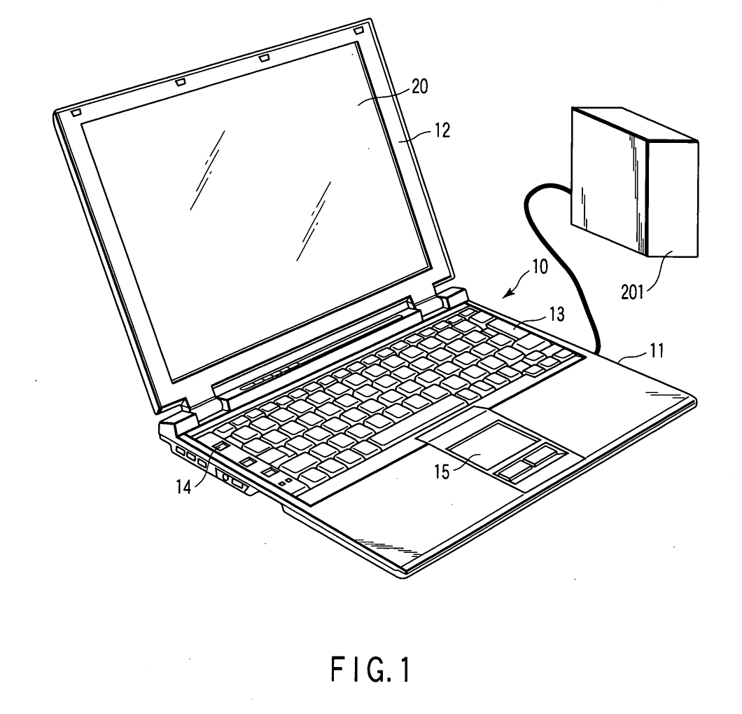

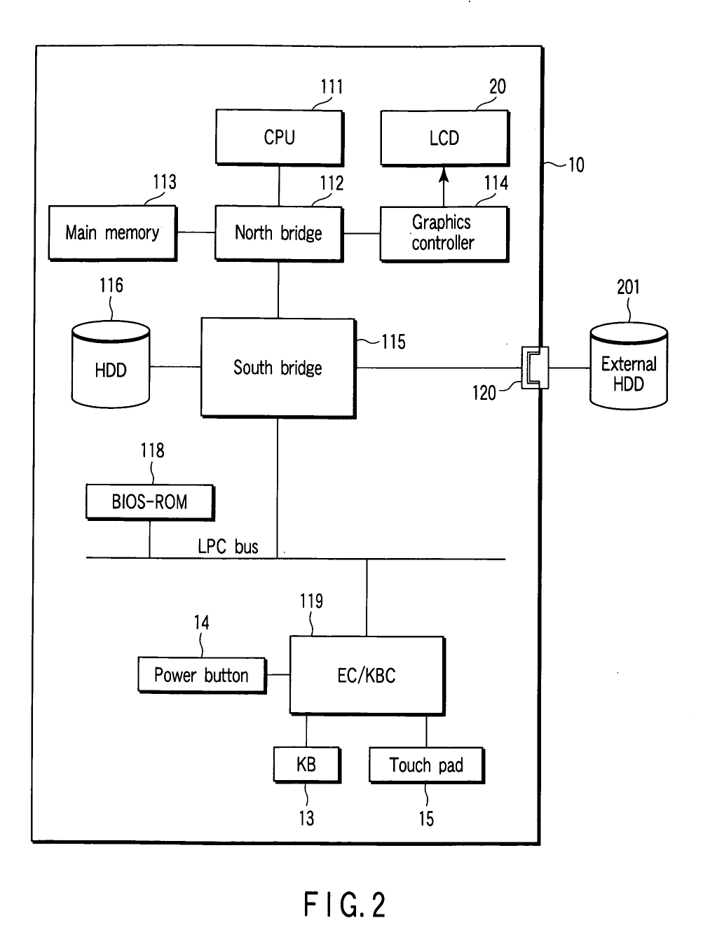

At first, a configuration of an information processing device regarding one embodiment of the invention will be described by referring to FIG. 1 and FIG. 2. The information processing apparatus is realized as a portable notebook-size personal computer 10 capable of being rechargeable battery-driven.

FIG. 1 is a perspective view seen from the front side of the computer 10 with a display unit thereof opened.

The computer 10 is composed of a computer main body 11 and a display unit 12. The display unit 12 has a display device consisting of a liquid crystal display (LCD) 20 built-in, and the display screen of the LCD 20 is positioned at an approximate center of the display unit 12.

The display unit 12 is supported by the main body 11 and attached to the main body 11 so as to be freely rotated between an opened position, in which the upper face of the main body 11 is exposed, and a closed position, in which the upper face of the main body 11 is covered. The main body 11 has a housing with a thin box shape, and a keyboard 13, a power button 14 to turn on and off a power source of the computer 10, and a touch pad 15 as an input device are disposed on the upper face.

An external HDD 201 and an external serial advanced technology attachment (eSATA) port provided for the main body 11 are connected with each other by a cable.

FIG. 2 shows an example of a system configuration of the computer 10.

The computer 10 includes a CPU 111, a north bridge 112, a main memory 113, a graphics controller 114, a south bridge 115, an internal HDD 116, a flash BIOS-ROM 118, an embedded controller/keyboard controller IC (EC/KBC) 119 and an eSATA port 120.

The CPU 111 is a processor to control operations of each component of the computer 10. The CPU 111 executes an operating system and a variety of application programs/utility programs to be loaded on the main memory 113 from the internal HDD 116. The CPU 111 also executes a system basic input output system (BIOS) stored in the BOIS-ROM 118. The system BIOS is a program to control hardware.

The north bridge 112 is a bridge device to connect between a local bus of the CPU 111 and a south bridge 115. The north bridge 112 also has a function of making a communication with the graphics controller 114 through an accelerated graphics port (AGP) bus, etc. Further, the north bridge 112 has a memory controller to control the main memory 113 built-in.

The south bridge 115 has an ATA controller which performs a communication to and from the internal HDD 116, and an eSATA controller which performs a communication to and from the external HDD 201.

The graphics controller 114 is a display controller which controls the LCD 20 to be used as a display monitor of the computer 10. The south bridge 115 is connected to each of a peripheral component interconnect (PCI) bus and a low pin count (LPC) bus.

The EC/KBC 119 is a one-chip microcomputer in which an embedded controller to manage a power source, the keyboard (KB) 13, the touch pad 15, etc. are integrated. The EC/KBC 119 turns on/turns off the computer 10 in response to the operations of the power button 14 by a user in cooperation with a power source circuit. The power source circuit generates a system power source to be supplied to each component of the computer 10 by using an external power source supplied through a battery or an AC adopter.

Next, a RAID function of the information processing apparatus will be described. Usually, a RAID-1 is constructed by two HDDs stored in the processing device. In the case of the information processing apparatus, RAID-1 is constructed by

the internal HDD 116 and the external HDD 201.

The RAID-1 records the same data on the two hard disks, duplicates the data on one HDD to other HDD.

In carrying the computer 10 to the outside, the computer 10 may be disconnected from the external HDD 201. If the computer 10 is disconnected from the external HDD 201, the RAID function is not implemented.

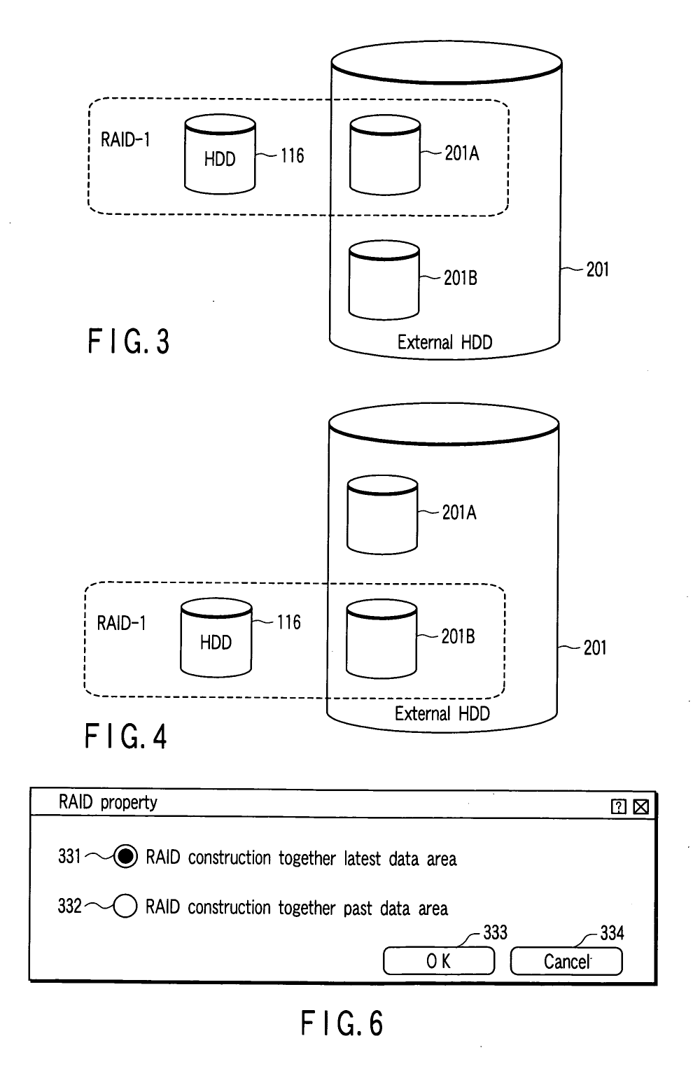

The external HDD 201 has a capacity larger than twice that of the internal HDD 116. As shown in FIG. 3 and FIG. 4, the external HDD 201 has a plurality of, for example, two areas 201A and 201B larger than the capacity of the internal HDD 116.

The RAID-1 is, as depicted in FIG. 3 and FIG. 4, constructed by a combination of the internal HDD 116 and the area 201A, or a combination of the internal HDD 116 and the area 201B. Constructing a RAID together with one area of the external HDD 201 makes it possible for the one area to protect the latest data therein. Changing the combination forming the RAID enables storing past data, so that the RAID function of the processing device may have the history of the changes in the internal HDD.

Next to this, a configuration to control the RAID function will be described with reference to FIG. 5. FIG. 5 is a block diagram illustrating the configuration of the RAID control function of the information processing device regarding one embodiment of the invention.

The RAID control function includes, as depicted in FIG. 5, an external HDD attaching/detaching recognition unit 301, a bitmap recording unit 302, a rebuilding control unit 303, an array information reading unit 304, a selecting window generation unit 305, a latest data area rebuilding unit 306, a past data area rebuilding unit 307, an array information changing unit 308, and a RAID control unit 310.

In FIG. 5, one area which has constructed a disk array right before is set as a latest data area 201R, and the other area is set as a past data area 201P.

The recognition unit 301 recognizes the attachment or detachment of the external HDD 201. The recognition unit 301 recognizes the attachment and the detachment of the external HDD 201 depending on information from an operation system.

After the detachment of the external HDD 201, the bitmap recording unit 302 records information in a changed area of the internal HDD 116 into a bitmap 321 on the internal HDD 116. The recording unit 302 manages the information by integral multiples of clusters to be managed by the operating system.

After the external HDD 201 is connected, the rebuilding control unit 303 executes control of processing to rebuild the data on the internal HDD 116 onto the external HDD 201.

The array information reading unit 304 reads out array information 322 stored in the BIOS-ROM 118. The array information 322 includes information showing which of the latest data area 201R and the past data area 201P correspond to which of the area 201A and the area 201B, respectively.

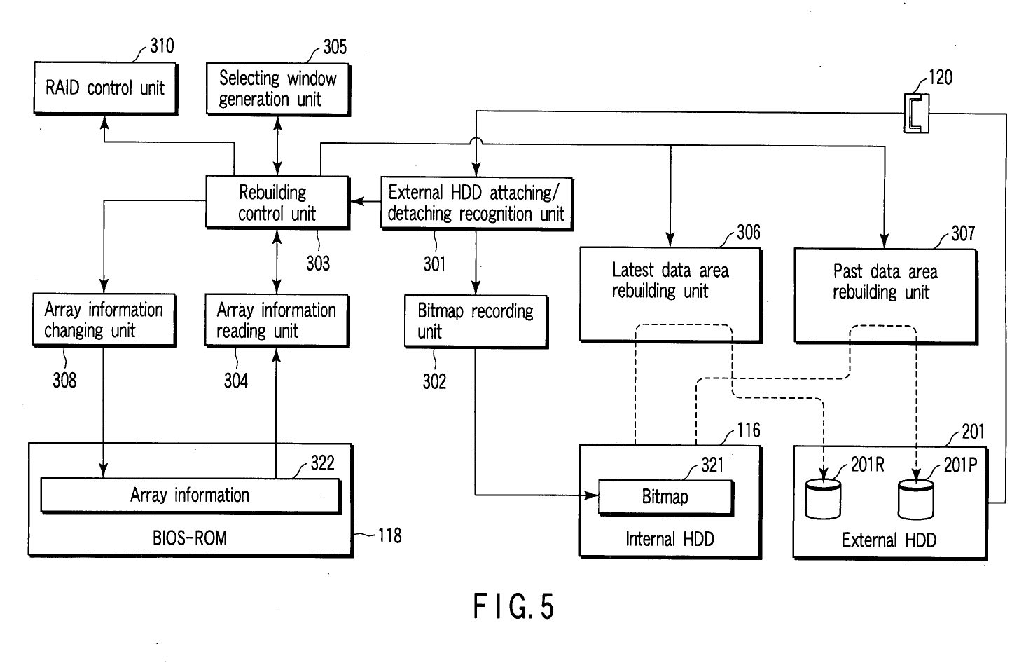

The selecting window generation unit 305 displays a window to inquire to a user which of the latest data area 201R and the past data area 201P constructs the RAID. FIG. 6 illustrates an example of a window which is displayed on the LCD 17 by the selecting window generation unit 305.

When the user operates an OK button 333 in a state in which a radio button 331 has been selected, the latest data area constructs the RAID. When the user operates the OK button 333 in a state in which a radio box 332 has been selected, the past data area constructs the RAID. If the user operates a cancellation button 334, the RAID is not constructed.

When the user-selects to construct the RAID by the latest data area 201R, the latest data area rebuilding unit 306 rebuilds the RAID in the latest data area 201R of the external HDD 201. The rebuilding unit 306 selectively rebuilds only an area in which the data on the internal HDD 116 has been updated after the external HDD is detached in accordance with the bitmap 321 on the internal HDD 116.

When the user selects to build the RAID by the past data area 201P, the past data area rebuilding unit 307 rebuilds the data in the past data area 201P in the external HDD 201. After all the data in the past data area 201P is deleted, the rebuilding unit 307 copies the data in the internal HDD 116.

The array information changing unit 308 changes array information 322 when the HDD area to build the RAID is changed in connecting the external HDD 201.

The RAID control unit 310 controls the RAID-1 through the internal HDD 116 and the external HDD 201.

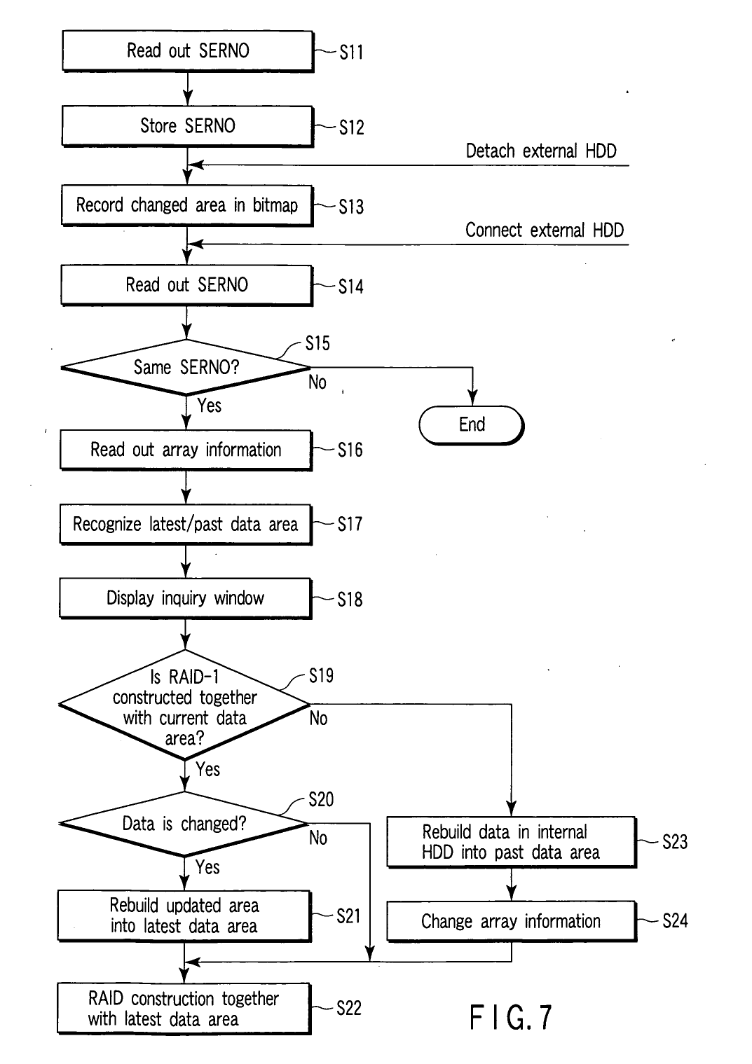

The following will describe the processing upon attaching and detaching the external HDD 201 with reference to FIG. 7.

When the RAID control unit 310 constructs the RAID-1 by the internal HDD 116 and by the latest data area 201R on the external HDD 201, the rebuilding control unit 303 reads out a serial number (hereinafter referred to as SERNO) of the external HDD 201 (Step S11) and stores it in the internal HDD 116 (Step S12).

When the external HDD attaching/detaching recognition unit 301 recognizes the fact that the external HDD 201 has been detached from the main body 11, the recognition unit 301 notifies the fact of the detaching of the external HDD 201 to the rebuilding control unit 303 and the bitmap recording unit 302. The bitmap recording unit 302 records the information about the updated area in the internal HDD 116 to the bitmap 321 (Step S13).

When recognizing the connection of the external HDD 201 to the main body 11, the recognition unit 301 notifies the fact of the connection of the external HDD 201 to the rebuilding control unit 303 and the bitmap recording unit 302.

The recording unit 302 stops the recording to the bitmap 321. The rebuilding control unit 303 reads out the serial number (SERNO) of the external HDD 201 (Step S14). The rebuilding control unit 303 determines whether or not the connected external HDD 201 is the identical external HDD 201 which has been connected at the time of disconnection by comparing the serial numbers (SERNOs) with each other (Step S15).

If it is determined that the HDDs are not the identical ones (No, in Step S15), the rebuilding control unit 303 terminates its operation without doing anything.

If it is determined that the HDDs are the identical ones (Yes, in Step S15), the rebuilding control unit 303 uses the array information reading unit 304 to read out the array information 322 from the BIOS-ROM 118 (Step S16).

The control unit 303 recognizes that the latest data area 201R and the past data area 201P correspond to which of the area 201A and the area 201B, respectively (Step S17).

The control unit 303 gives an order to the selecting window generation unit 305 so as to display the window for inquiring to the user which of the latest data area 201R and the past data area 201P constructs the RAID-1 in response to the array information 322. As shown in FIG. 6, the selecting window generation unit 305 displays a window (Step S18).

When the user selects the area, the rebuilding control unit 303 determines whether or not the RAID is selected to be constructed by the latest data area 201R (Step S19). If it is determined that the RAID is selected to be constructed by the latest data area 201R (Yes, in Step S19), the control unit 303 refers to the bitmap 321 to determine whether the area of which the data has updated exists or not (Step S20).

If it is determined that the updated area exists (Yes, in Step S20), the control unit 303 refers to the bitmap 321, and selectively rebuilds the updated area into the latest data area 201R to recover duplication (Step S21). After the duplication is recovered (Step S20), or if it is determined that the updated area does not exist (No, in Step S19), the rebuilding control unit 303 transfers the control to the RAID control unit 310, and the RAID control unit 310 constructs the RAID-1 by means of the internal HDD 116 and the latest data area 201R of the external HDD 201 (Step S22). The control unit 310 reads out the array information 322 to construct the RAID-1 together with the latest data area 201R shown by the array information and the internal HDD 116.

In Step S19, if it is determined that the user has not selected to construct the RAID by the latest data area 201R (No, in Step S19), the rebuilding control unit 303 rebuilds the data in the internal HDD 116 into the past data area 201P (Step S23). For rebuilding the data, after the data in the past data area 201 is deleted once, the rebuilding control unit 303 copies all the data in the internal HDD 116.

After the rebuilding processing is completed, the control unit 303 issues a command to the array information changing unit 308 so as to change the area which has been the latest data area into the past data area, and the area which has been the past data area into the latest data area (Step S24).

After the status is changed in Step S24, or if it is determined that the updated area does not exist in Step S22 (No, in Step S22), the rebuilding control unit 303 transfers the control to the RAID control unit 310, and constructs the RAID-1 by the internal HDD 116 and the latest data area 201R in the external HDD 201 (Step S22). The RAID control unit 310 reads out the array information 322, and constructs the RAID-1 by the latest data area 201R shown in the array information and by the internal HDD 116.

The aforementioned processing enables switching the area to construct the RAID-1 together with the internal HDD 116, and enables effectively using the external HDD 201 having a large capacity.

Although the embodiment given above has described the case of the connection of the external HDD 201 to the eSATA port 120, the external HDD 201 may be connected to the external connecting port such as a universal serial bus (USB) port and an IEEE1394 port. The areas consisting of the RAID may be switched among three or more areas by using the external HDD 201 which is three or more times larger than the capacity of the internal HDD 116. When switching three or more areas, it is preferable to add information of the date and hour at which the RAID is constructed finally to the array information and to show the information on the data and hour on the window by which the user selects the area.

To rebuild the past data, rebuilding only a difference by storing the information of the difference between the data in the past data area and the data in the internal HDD in a bitmap manner other than the rebuilding of all the data is a possible approach.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device, comprising:
a body;
an internal storage device configured to have a first capacity and to be disposed in the main body;
a connecting port configured to be connected by a second storage device, having a plurality of areas to duplicate data to be stored by the internal storage device, and of which the capacity of each area is larger than the first capacity;
a connection recognizing unit configured to recognize the fact that the second storage device is connected to the connecting port;
an inquiring unit configured to inquire to a user which of areas in the second storage device is selected for constructing a disk array, when the connection is recognized;
a rebuilding unit configured to rebuild the data in the internal storage device into the area selected by the user in response to the inquiry from the inquiring unit; and
a disk array construction unit configured to construct the disk array by an area corresponding to the area selected by the user.

2. The device according to claim 1, further comprising:
an array information storage unit configured to store array information showing an area which has constructed the disk array right before; and
an array information changing unit configured to change array changing the array information in the array information storage unit when the area selected by the user and the area shown by the array information are different from each other.

3. The device according to claim 2, further comprising:
a disconnection recognition unit configured to recognize disconnection between the connecting port and the external storage device; and
an information generation unit configured to generate information of an area in which the data in the internal storage device has been changed, after the disconnection recognition unit recognize disconnection, wherein when the area selected by the user is the same as the area shown by the array information, the rebuilding unit selectively rebuilds the area changed in response to the generated information.

4. The device according to claim 2, wherein when the area selected by the user and the area shown by the array information are different from each other, the rebuilding unit deletes data in the area selected by the user then transfers all the data in the internal storage device to the area selected by the user.

5. The device according to claim 1, wherein the connecting port is selected from among a universal serial bus port, an IEEE1394 port, and an external serial advanced technology attachment port.

6. A disk array construction method of an information processing device configured to include an internal storage device configured to have a first capacity disposed in a main body; and a connecting port configured to be connected by a second storage device, having a plurality of areas to duplicate data to be stored by the internal storage device, and of which the capacity of each area is larger than the first capacity, comprising:
recognizing connection of the external storage device to the connecting port;
inquiring to a user which of areas in the second storage device is selected to construct a disk array, when the connection is recognized;
rebuilding the data in the internal storage device into the area selected by the user; and
constructing the disk array by an area corresponding to the area selected by the user.

7. The method according to claim 6, further comprising:
referring to array information showing the area which has constructed the disk array right before, wherein the area changed in response to the generated information is selectively selected, when the area selected by the user differs from the area shown by the array information.

8. The method according to claim 7 further comprising:
recognizing disconnection between the connecting port and the external storage device; and
generating information of an area in which the data in the internal storage device is changed, after the recognizing, wherein when the area selected by the user is the same as the area shown by the array information, the changed area is selectively rebuilt in response to the generated information.

9. The method according to claim 7, wherein when the area selected by the user differs from the area shown by the array information, after the data in the area selected by the user is deleted, all the data in the internal storage device is transferred to the area selected by the user.

10. The method according to claim 6, wherein the connecting port is selected from among a universal serial bus port, an IEEE1394 port, and an external serial advanced technology attachment port.
